(19) United States
(12) Patent Application Publication
(10) Pub. No.: US 2011/0020122 A1
(43) Pub. Date: Jan. 27, 2011

(54) INTEGRATED CONDITION BASED MAINTENANCE SYSTEM FOR WIND TURBINES

(75) Inventors: Girija Parthasarathy, Maple Grove, MN (US); Wendy Foslien Graber, Woodbury, MN (US); Tom Brotherton, Poway, CA (US)

Correspondence Address: HONEYWELL/SLW;Patent Services, 101 Columbia Road, P.O. Box 2245, Morristown, NJ, 07962-2245, US

(73) Assignee: Honeywell International Inc., Morristown, NJ (US)

(21) Appl. No.: 12/841,301

(22) Filed: Jul. 22, 2010

Related U.S. Application Data
(60) Provisional application No. 61/228,443, filed on Jul. 24, 2009.

(51) Int. Cl. F03D 11/00; G06F 19/00

(52) U.S. Cl. 416/61; 700/90

(57) ABSTRACT

A computer implemented method includes receiving condition information from a plurality of condition detection sensors coupled to a wind turbine and receiving wind turbine controller information. An anomaly detection algorithm is applied to identify maintenance activities for the wind turbine as a function of both the wind turbine condition information and the wind turbine controller information.

### RELATED APPLICATION

This application claims priority to U.S. Provisional Application Ser. No. 61/228,443 (entitled INTEGRATED CONDITION BASED MAINTENANCE SYSTEM FOR WIND TURBINES, filed Jul. 24, 2009) which is incorporated herein by reference.

### BACKGROUND

Wind turbines often operate in severe, remote environments and require frequent scheduled maintenance. The cost of unscheduled maintenance due to undetected failures is high both in maintenance support and lost production time.

### BRIEF DESCRIPTION OF THE DRAWINGS

FIG. 1 is a block diagram of a health monitoring system for a wind turbine generator according to an example embodiment.

FIG. 2 is a block schematic representation of systems and the information collected in each according to an example embodiment.

FIG. 3 is a flow diagram of a method of monitoring the condition of a wind turbine generator according to an example embodiment.

FIG. 4 is a block diagram of a computing device for implementing one or more algorithms according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Condition based maintenance (CBM) enables high reliability and low maintenance costs by eliminating unnecessary scheduled maintenance through continuous monitoring. An integrated condition based monitoring system accounts for health monitoring of the performance degradation of a core process, mechanical system faults, such as bearings, shafts and gears, electrical system faults such as power electronics, controller, and generator faults, and material or structural faults, such as fatigue cracks and corrosion in a wind turbine. In addition, condition based monitoring may include a system-wide reasoner and decision support software that isolates the right causes of failure and prioritizes maintenance actions. Multiple systems are targeted for monitoring through the use of one integrated hardware box for data collection and an integrated analysis and software system for dissemination of results.

Two major challenges are the improvement of wind turbine performance and reduction in operating and maintenance costs. After the capital costs of commissioning wind turbine generators, the biggest cost for owners is maintenance. A reduction in maintenance and operating costs can reduce a payback period considerably and can provide the impetus for investment and widespread acceptance of this clean energy source, helping to achieve a goal of 20% of electrical demand being supplied by wind energy.

A comprehensive integrated CBM system for equipment or processes accounts for health monitoring of (1) the performance degradation of the core process, (2) mechanical system faults (such as bearings, shafts and gears) (3) electrical system faults (such as power electronics, controller, generator faults), (4) material or structural faults (such as fatigue cracks and corrosion) and (5) hydraulic system faults. In addition, a system-wide reasoner and decision support system isolates the right causes of failure and prioritizes maintenance actions.

In one embodiment, the integrated condition based maintenance system utilizes one electronics box that collects data from all sensors and sensor systems. Such sensors and sensor systems may include accelerometers and tachometers for vibration monitoring of bearings and gearboxes, sensor data at the wind turbine controller, or supervisory control and data acquisition (SCADA), generator electrical signals, structural health sensors such as fiber optic strain sensor system, and any other subsystem monitoring device. The system uses a data transmission and communication systems, such as HUMS (health and usage monitoring system), including a MWS (maintenance work station) and iMDS (intelligent machinery diagnostic system) web server. Analysis software has the ability to reason amongst the health indicators from different subsystems to resolve conflicts amongst indicators, and provide a prioritized list of maintenance actions.

In one embodiment, the combination of SCADA monitoring and condition monitoring, including vibration and structural health monitoring in a single system provides an integrated view of the system health. Examples of sensed parameters for different parts of the wind turbine generator include vibration, temperature and speed sensors for mechanical systems. Pressure and temperatures may be sensed for hydraulic systems. Current, voltage, power, and vibration may be sensed for electrical systems. Vibration, strain, direct defect sensing through ultrasonic sensing, acoustic emission, etc., may be used for structural systems. Electronic systems may be monitored by collecting control/actuation signals, performing signal injection etc. Performance monitoring in one embodiment includes all controller data, including rotor and generator speeds, power, yaw, pitch, current, voltage, temperatures.

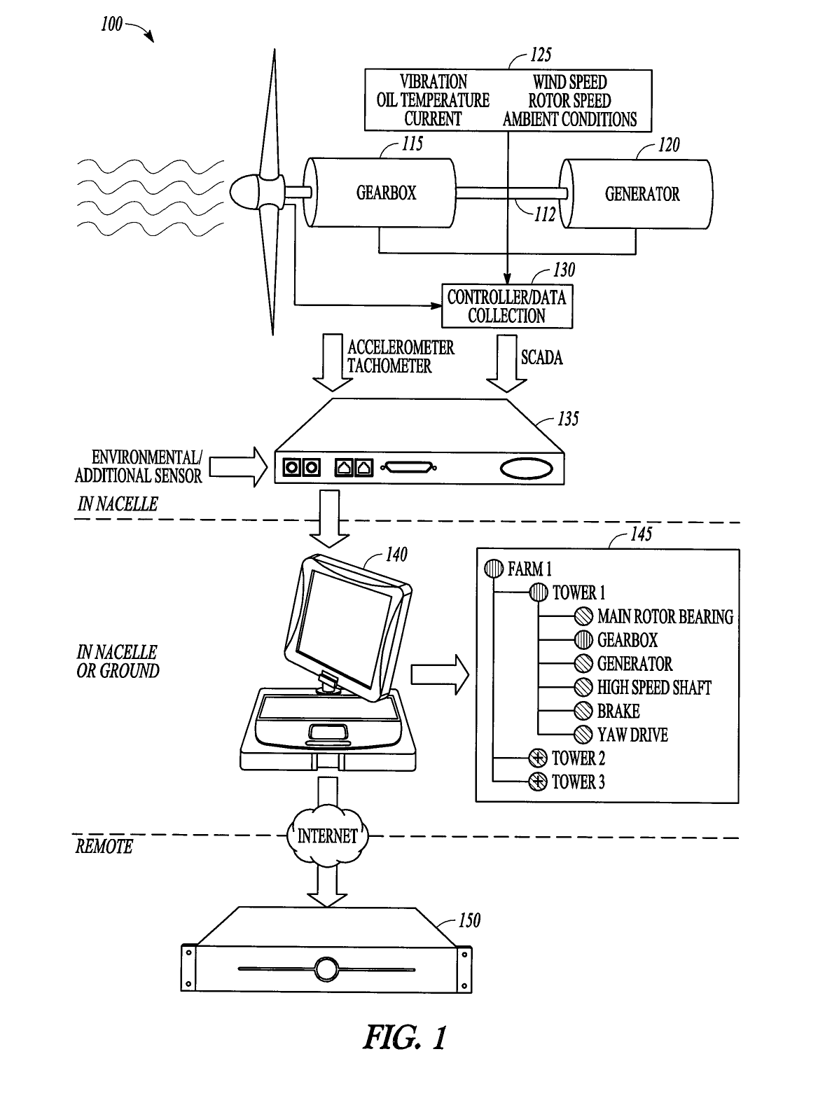

A condition based maintenance system 100 for a wind turbine generator is shown in block diagram form in FIG. 1. System 100 in one embodiment includes a blade structure 110, gearbox 115 coupled to the blade 110, a drive train or shaft 112 coupling the gearbox 115 to a generator 120, an array of sensors 125 positioned to monitor the system 100, and a controller 130 to control the wind generator and collect data from the sensors 125. A plurality of processing elements such as maintenance station 135, ground station 140, and central controller 150 may be located in a nacelle of the wind generator or on the ground, and interconnected either wirelessly or by wired connections.

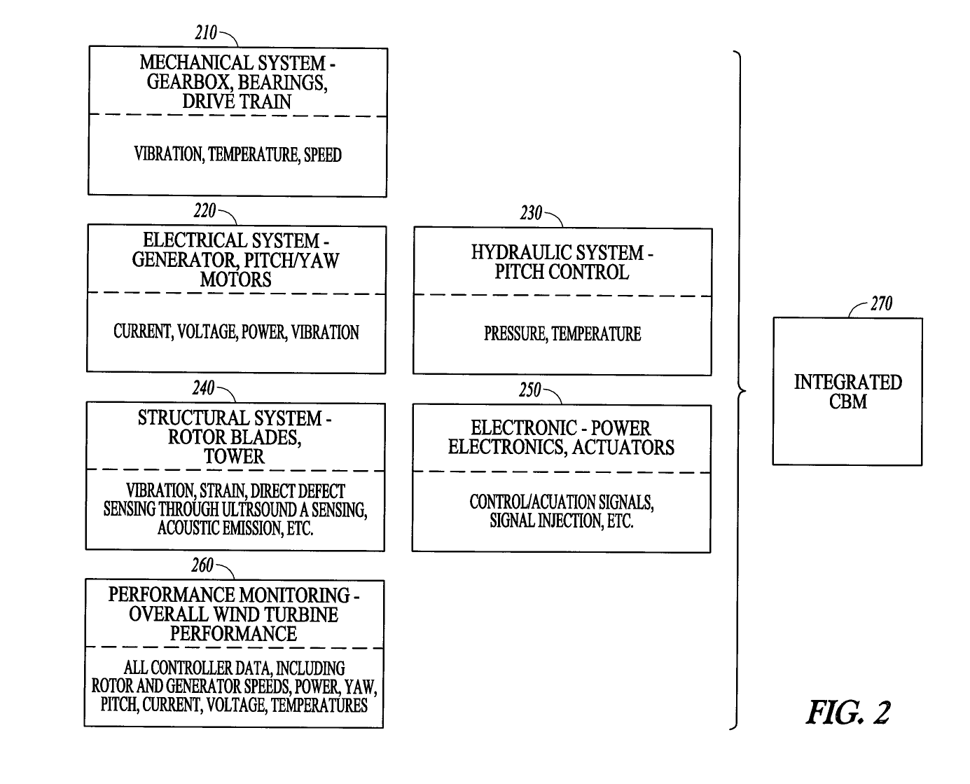

Instrumentation and data collection is the basic infrastructure utilized in CBM system 100. Sensors 125 include sensors for both SCADA monitoring and vibration monitoring. Many different types of sensors may be used for different systems in CBM system 100. For example, as shown a block schematic representation in FIG. 2, sensors and electrical signals are collected to determine the overall health of an integrated set of systems. Sensors used for a mechanical system 210 that includes gearbox 115, bearings, and the drive, train include vibration, temperature, and speed such as tachometer sensors.

An electrical system 220 includes the generator 120, and pitch and yaw motors. Current, voltage, power, and vibration information may be utilized to measure the health of the electrical system.

A hydraulic system 230 for pitch control may utilize pressure and temperature sensors. A structural system 240 includes rotor blades and a tower used to support the wind turbine generator above the ground. The structural system 240 may include vibration and strain sensors. Direct defect sensing may be performed through ultrasonic sensing, acoustic emissions, and other types of sensing.

An electronic power system 250 may include control/actuation signals and signal injection, etc. A performance monitoring system 260 monitors the overall wind turbine performance, and includes all controller data, including rotor and generator speeds, power, yaw, pitch, current, voltage, and temperatures. Other parameter may be measured in further embodiments. Together, all the sensed parameters and signals comprise an integrated CBM as indicated at 270.

Mechanical failure modes such as bearing failures may be sensed and anticipated prior to failure occurring such that maintenance may be scheduled to minimize wind turbine generator down time.

The system 100 may be used for reducing, even eliminating, required scheduled maintenance, identifying faults that would not have been detected under existing maintenance procedures, reducing unscheduled component removal/replacement. The vibration monitoring system includes real-time data collection and processing component 130 to be installed in the wind turbine nacelle, along with maintenance station 135 for download, summary, and specification of maintenance actions for the user. Real-time data collection and processing component 130 receives SCADA data, such as all controller data, including rotor and generator speeds, power, yaw, pitch, current, voltage, and temperatures. The maintenance station 135 may be located in the nacelle, and collects and records sensed vibration data and SCADA data. Maintenance station 135 may also perform some data pre-processing and feature extraction computations.

The system 100 includes monitoring system sensors 125, and rack-mounted equipment such as station 135 for at-site data collection and processing. Still further environmental sensors may be used to provide further data to maintenance station 135.

A computer that runs ground station 140 software may be used by the maintenance station 135 for download, summary display, and recommendation of action items for one or more wind generators as indicated in block 145 showing a tree representation of a wind generator farm that includes multiple towers with components listed for tower 1. Ground station 140 may also perform detection and diagnostic algorithms, as well as prognostic and remaining life algorithms.

All data collected by GBS systems can be seamlessly downloaded to an intelligent Machinery Diagnostic System (iMDS) Server or central controller 150 for archive and analysis. Central controller 150 may perform reasoning to make maintenance scheduling decisions, including prioritization. The entire system may be configured using a software tool called the iMDS Database Setup Tool.

In further embodiments, multiple ground stations 140 may be coupled to the central controller 150 via a network connection, such as the Internet.

Algorithms for processing the sensor data may be performed at one or more of the processing component 130, maintenance station 135, ground station 140, and central controller 150 in various embodiments. In one embodiment, central controller 150 may be used to coordinate maintenance efforts for towers located on one or more farms based on predictive maintenance actions generated from the collected data for each wind generator on a tower.

Condition based maintenance (CBM) and performance monitoring have a much broader potential for operator/owner benefit than just basic monitoring for mechanical failures. The system 100 utilizes gathered information on the top failure modes from wind farm operators, data from wind turbine SCADA feeds, and diagnostic and prognostic analytics to complement established HUMS mechanical condition indicators.

Top failure modes are identified that can benefit from CBM by gathering information from actual operating wind turbine generators and comparing the data to actual failures. SCADA data for multiple wind turbines or for an entire wind farm may be gathered to help identify the failure modes to help develop fault detection algorithms.

Anomaly detection for individual wind turbines may be developed with a data set collected. Analysis may be done but is not limited to using principal component analysis (PCA), and non-linear methods. For example, SOFM (Self Organizing Feature Maps) is a non-linear method by which unsupervised learning can be used in a set of data with unknown features, for categorizing them into groups with similar features. A set of algorithms that look for anomalies in a sensor within a sensor group may be used in detecting anomalies with the SCADA data.

In one embodiment, performance monitoring using anomaly detection may be used for a population of wind turbines, such as those on a wind farm. The relationship at the system level, between different wind turbines on the farm may be exploited. Each wind turbine in a particular wind farm or geographic location has a relationship to the other wind turbines operating in its vicinity, in terms of wind speed experienced, rotor speed, and generator output. Correlation and monitoring on a continuous basis may be done to determine if the relationship is broken because of an anomaly. Scatter plots and confidence interval thresholds, for raw data as well as PCA outputs such as Q-statistics may be used to perform the correlation.

In one embodiment, different CBM configurations may be used for different wind turbine models The setup tool provided with Honeywell's Zing™ Ware HUMS software works well to define configurations that are set up once and duplicated over multiple machines. The setup tool capability is extensive, allowing aircraft as diverse as the Chinook Helicopter (CH-47D) and Blackhawk (UH-60) to be configured without source code changes. This level of flexibility enables rapid configuration and tuning of HUMS algorithms and is a significant factor in the success of Honeywell's HUMS deployment. In one embodiment, the wind turbine CBM system employs a similar level of flexibility and system integration. A reference model may be defined for wind applications using a structure similar to Honeywell's HUMS data model. The reference model includes equipment characteristics and key tuning parameters for all subsystem health monitoring algorithms.

In some embodiments, various analytics may be used for advanced CBM system 100. Additional diagnostic and prognostic analytics are described below. Different mathematical and statistical techniques may also be used. These techniques include but are not limited to, PCA/PLS, clustering, trend analysis, neural networks, data fusion, knowledge fusion and others.

Statistical techniques may be used to monitor rotor performance for given wind speeds by comparing actual versus expected. Generator power produced can also be monitored in the same way. In one embodiment, icing detection may also be performed utilizing specific seasonal performance features and weather conditions.

Anomaly detection for a wind turbine population may be performed. The wind turbines in a wind farm do not experience identical conditions. During normal operation, the wind turbines may have a certain correlation with each other. An evolving fault in one wind turbine could show up as an anomaly in the population data, which can be integrated as additional conditions to those available with the HUMS based system.

Generator electrical characteristics in the SCADA data may be used to detect generator electrical and mechanical problems.

Generator fault detection may be performed using analytics based on the generator electrical characteristics.

Health monitoring may be performed to improve turbine reliability and reduce operation and maintenance costs through continuous monitoring of wind turbines. Condition Based Maintenance (CBM) technology is applied to wind turbines.

Early detection of component failures that cause the highest failures in wind turbines are addressed by the system 100. Operational failures associated with the gearbox 115 and generator components 120 are significant, accounting for the largest downtime and expense for repair. The system 100 provides accurate prediction of bearing and gearbox mechanical failures through vibration monitoring. Performance, electrical and blade 110 structural monitoring cover high impact failures in the rest of the subsystems. Comprehensive health analysis provided by system 100 provides full coverage of the highest cost and most frequent failures, resulting in reduction in cost of unscheduled maintenance, longer scheduled maintenance intervals, shorter downtimes that reduce loss of revenue, and optimum maintenance scheduling.

In one embodiment, the system 100 is configurable for application to new sensors, new algorithms, and new equipment types and components by changing database setup tables. The system can also input SCADA bus data, which will enable use of the architecture in various wind turbine CBM integrations.

The vibration measurement and diagnostic processing may be used to develop component-specific diagnostics that provide robust indicators of mechanical faults. To develop robust indicators, factors such as sensor location and type, measurement, diagnostic processing, and limits setting are taken into account. The data collection hardware also embeds sophisticated processing capability including Asynchronous Time Domain (ATD), Synchronous Time Domain (STD), Asynchronous Frequency Domain (AFD), and Synchronous Order Domain (SOD). The accelerometer and tachometer data collected is pre-processed with these methods. Several vibration monitoring algorithms operate on the data structures thus produced and output condition indicators. These include Spectral Peak 1 and 4, Envelope analysis, figure of merit 0 and 4, and many others.

Automated anomaly detection algorithms use wind turbine supervisory control and data acquisition (SCADA) data. Predictive trend monitoring (PTM) and the Zing™ family of products for aircraft engines and auxiliary power units (APU) as well as event detection methods from the process industry may also be used. Performance monitoring includes analysis of data using proven mathematical and statistical approaches.

Performance is described in the context of the underlying process physics of the wind turbine, and may use model-based and data-based approaches. As the turbine components deteriorate, the efficiency with which wind energy is converted to electrical energy decreases. Performance degradation can indicate a number of problems, such as blade aerodynamic degradation due to leading and trailing edge losses, dirt or ice buildup on blades, loss due to drivetrain misalignment, friction caused by bearing or gear faults, generator winding faults, or even pitch or yaw control system degradation. Performance parameter calculation, anomaly detection, fault diagnosis, predictive trending and future projection may be used in various embodiments.

Model-based diagnostics may be used to detect faults and degradations. Using a wind turbine model, and operating conditions, model-prediction residuals are computed. Fault parameter severities are then estimated based on the residuals. Techniques such as generalized least squares (GLS) may be used for estimation of fault parameters.

In one embodiment (PCA) is used to process sensed information about the system 100. Multivariate statistics may be applied to complex processes to provide better indication of problems than univariate statistics. One approach to detecting changes in process performance is to use PCA and partial least squares (PLS) regression.

Using PCA, the analysis of a large number of process variables from an area or sub-process is reduced to a subset of linear combinations. These linear combinations of process variables are also known as latent variables. The original inputs can be thought of as projecting to a subspace by means of a particular transformation. Unlike the raw inputs, the latent variables are guaranteed to be independent.

A plane of normal operation establishes a benchmark from which to judge future process states. Confidence limits are established around this plane or model to determine the boundaries of the subspace. Fault detection or process monitoring is done by periodically taking new values of the input variables that represent a new process condition or state. Early detection of changes in the process can be detected as the statistics either leave the model hyperplane or exceed statistical limit boundaries within the hyperplane.

Self-organizing feature maps may also be used. Clustering algorithms are methods to divide a set of n observations into g groups so that members of the same group or cluster are more alike than members of different groups. A self-organizing feature map (SOFM) is a type of unsupervised clustering algorithm, forming neurons located on a regular grid, usually of 1- or 2-dimensions. SOFM can detect regularities and correlations in their input and adapt their future responses to that input by learning to classify input vectors. Based on the competitive learning process, the neurons become selectively tuned to input patterns so that neurons physically near each other in the neuron layer respond to similar input vectors. Since the health condition (normality or failure) for each data point is not available in the field, SOFM is particularly suited to find patterns in the data and without target class labels. Honeywell possesses an original SOFM-based technology and has utilized it in the area of fault diagnosis of gas turbine engines.

Sensor validation, isolation, and recovery may also be performed. Analytical redundancy among sensors is captured and the readings of a group of correlated sensors are mapped into an estimation set of an identical group. In the nominal case, the association between the actual and the estimated values are maintained, and the residuals remain small. However, when there is an appreciable sensor fault, the associated model estimate diverges from the actual sensor reading. This difference is driven by the fact that the associated model estimate is not a time series prediction but an expectation computed based on the remaining associated sensors that have not failed. Sensor recovery of appreciable sensor faults is then accomplished by taking advantage of this feature, and the divergence is removed incrementally by iterative associative model estimation feedback.

The published literature on wind turbine reliability shows that unscheduled generator failure is a major contributor to the overall turbine downtime. System 100 targets generator fault detection using a hybrid approach that utilizes model and spectral analysis based methods of fault detection, along with an advanced trending approach to generate the requisite generator prognostics indicator. This approach for condition monitoring for the wind turbine induction generator system will cover both electrical and mechanical faults. The approach leverages experience with induction motor fault detection using both signature and model based methods to provide coverage for electrical and mechanical faults. It utilizes data collected from the generator terminal currents and voltages, vibration signals from the generator bearings accelerometers; and thermocouples monitoring the critical bearings, generator exciter and the generator windings. Within this construct the presence of multiple sensors is exploited; various sensing modalities along with known physics of failure or mechanistic models to calculate health indicators for the actuator system. For example, in the case of generator eccentricity, informational redundancy may be exploited by using one or both the bearing accelerometer signal and the generator voltage signature to detect the underlying fault. The use of multiple sensor modalities improves the detection accuracy and reduces false alarm rate of the diagnostics system.

Structural health monitoring of wind turbine blades may also be provided in further embodiments. Fiber optic sensors may be used for distributed strain measurement of the blades. Structural models may be used to interpret the sensors to provide information on incipient structural defects, such as location, size, and probability of failure.

Structural health monitoring may also be used for tower structural monitoring.

Usage based monitoring, diagnostics and prognostics of several components may be performed. By keeping track of the operations (such as speeds, temperatures, starts and stops, hours or frequency of operation in particular operating regimes) of components such as the gearbox, rotor, yaw and pitch motors and other components, usage based degradation can be monitored. Usage statistics also provide another piece of information and increase the confidence for fault diagnostics.

An effective approach for wind generator configuration and tuning is used to ensure successful CBM deployment. A standard configuration approach, using tools that facilitate broad deployment of health monitoring algorithms to multiple wind turbine configurations.

Equipment specifications and SCADA data configuration are gathered across the multiple wind turbine models in operation. The information may be used to define a reference model for wind applications. The reference model may include equipment characteristics and key tuning parameters for both HUMS and SCADA algorithms.

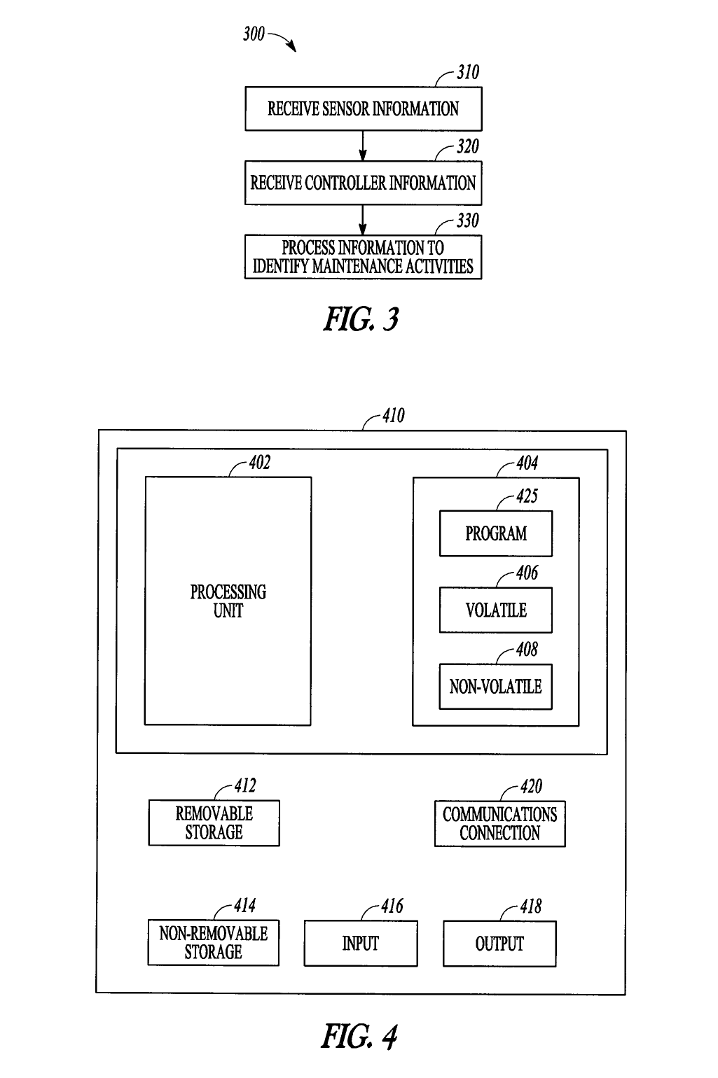

FIG. 3 is a flow diagram illustrating a computer implemented method 300 of monitoring wind generators for determining appropriate maintenance actions based on the sensed condition of the wind generators. At 310, wind turbine condition sensor information is received from all sensors associated with the system 100 in one embodiment. The data may be stored on a computer readable memory device for immediate or future use. At 320, wind turbine controller information regarding electrical performance of the wind turbine is received and stored on a computer readable device. The information is then used at 330 by applying an automated anomaly detection algorithm via the computer to identify maintenance activities for the wind turbine integrating both vibration and SCADA data. Maintenance activities are thus performed for the wind energy turbine in an integrated manner as a function of both the wind turbine health sensor information and the wind turbine controller information.

In further embodiments, the received information is processed via a computer to convert to at least one of a time domain and a frequency domain representation. The structural health sensor information may include one or more of strain, acoustic emission, and optical or piezoelectric sensor information. Processing structural health sensor information may be done to produce an image of a monitored structure. Automating the structural health sensors may be done to gather and transmit data at particular regimes of operation or at trigger conditions.

In some embodiments, further sensor information such as at least one of generator, gearbox bearing, and lube oil temperature, yaw position and pitch position information, rotor, gearbox, and generator speed, generator terminal, currents, voltages, and power electrical signals may be received and used to identify maintenance activities. In still further embodiments, inner control loop data may be received and used. One example of such inner control loop data includes demanded and measured pitch angle. Further sets of data that includes variations from requested control actions and actual measurements may also be used.

A block diagram of a computer system that executes programming for performing the above algorithm is shown in FIG. 4. A general computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer—readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a computer-readable medium.

The Abstract is provided to comply with 37 C.F.R. §1.72(b) is submitted with the understanding that it will not be used to interpret or limit the scope or meaning of the claims.

1. A computer implemented method comprising:
receiving and storing on a computer readable device, wind turbine condition information from multiple sensors monitoring the wind turbine;
receiving and storing on a computer readable device, wind turbine controller information regarding performance of the wind turbine; and
applying an automated anomaly detection algorithm via the computer to identify maintenance activities for the wind turbine as a function of both the wind turbine condition information and the wind turbine controller information.

2. The computer implemented method of claim 1 and further comprising processing the received information via a computer to convert to at least one of a time domain and a frequency domain.

3. The computer implemented method of claim 1 wherein the condition information includes one or more of strain, acoustic emission, and optical or piezoelectric sensor information.

4. The computer implemented method of claim 1 and further comprising processing condition information to produce an image of a monitored structure.

5. The computer implemented method of claim 1 and further comprising automating the sensors to gather and transmit data at particular regimes of operation or at trigger conditions.

6. The computer implemented method of claim 1 and further comprising receiving further sensor information regarding the condition of at least one of generator, gearbox bearing, and lube oil temperature, yaw position and pitch position information, rotor, gearbox, and generator speed, generator terminal, currents, voltages, and power electrical signals.

7. The computer implemented method of claim 1 and further comprising receiving inner control loop data on demanded and measured pitch angle.

8. A computer implemented method comprising:
receiving condition information from a plurality of sensors coupled to a wind turbine;
receiving performance information proximate the wind turbine;
processing the received information to convert to at least one time domain and frequency domain; and
combining the received information at an integrated maintenance station and applying an automated anomaly detection algorithm to identify maintenance activities for the wind turbine.

9. The computer implemented method of claim 8 and further including processing the received information to convert at least some of the information to a synchronous order domain.

10. The computer implemented method of claim 8 and further comprising applying principal component analysis to the domain information to reduce the information to a subset of linear or non-linear combinations.

11. The computer implemented method of claim 10 and further comprising clustering observations as a function of similarity of the observations to each other.

12. The computer implemented method of claim 8 wherein the sensor information includes one or more of strain, acoustic emission, and optical or piezoelectric sensor information.

13. The computer implemented method of claim 8 and further comprising processing sensor information to produce an image of a monitored structure.

14. The computer implemented method of claim 8 and further comprising automating the sensors to gather and transmit data at particular regimes of operation or at trigger conditions.

15. The computer implemented method of claim 8 and further comprising receiving further sensor information and signals including at least one of generator, gearbox bearing, and lube oil temperature, yaw position and pitch position information, rotor, gearbox, and generator speed, generator terminal, currents, voltages, and power electrical signals.

16. A system comprising:
a wind generator having a blade coupled to a gearbox coupled to a generator;
a plurality of sensors arranged to sense multiple condition and controller parameters associated with the wind generator; and
a controller coupled to the wind generator to receive information from the plurality of sensors, to control operation of the wind generator, and to identify maintenance activities for the wind generator as a function of the information from the plurality of sensors when the information corresponds to a predicted failure of a portion of the wind generator.

17. The system of claim 16 and wherein the plurality of sensors provide information regarding the condition of at least one of generator, gearbox bearing, and lube oil temperature, yaw position and pitch position information, rotor, gearbox, and generator speed, generator terminal, currents, voltages, and power electrical signals.

18. The system of claim 16 wherein the controller performs principal component analysis to the sensed information to reduce the information to a subset of linear or non-linear combinations.

19. The system of claim 16 wherein the sensors provide structural health sensor information.

20. The system of claim 16 and further comprising a central controller coupled to receive information from multiple systems regarding multiple wind generators in a farm of wind generators.
